(19) United States
(12) Patent Application Publication
(10) Pub. No.: US 2025/0053475 A1
(43) Pub. Date: Feb. 13, 2025

(54) CORRECTIVE ACTIONS FOR CONTROLLING INDUSTRIAL PROCESSES

(71) Applicant: HONEYWELL INTERNATIONAL INC., Charlotte, NC (US)

(72) Inventors: Murugesh Palanisamy, Bangalore (IN); Viraj Srivastava, Bangalore (IN); Srikant Srinivasan, Bangalore (IN)

(21) Appl. No.: 18/232,355

(22) Filed: Aug. 10, 2023

(51) Int. Cl. G06F 11/07

(52) U.S. Cl. CPC G06F 11/0793; G06F 11/0736

(57) ABSTRACT

Example techniques to control operations in an industrial facility is described. In an operation, operating parameters of an equipment from amongst a plurality of equipments installed in the industrial facility are monitored. A range of values is predefined for each of the operating parameters of the equipment. An operating parameter of the equipment that deviates from the corresponding predefined range of values is identified. A dataset is queried to identify past instances of deviation in the operating parameter that are within a specified range of deviation to the deviation in the operating parameter of the equipment. A corrective action is selected from amongst at least one corrective action in the dataset. The corrective action is implemented to correct the deviation in the operating parameter of the equipment.

### BACKGROUND

In industrial facilities, such as oil, gas, or petrochemicals refineries or mining facilities, there may be a wide range of processes and equipments in operation. These equipments may be susceptible to experiencing downtime and occasional deviations from their normal or predefined operating parameters. The complex nature of industrial processes necessitates proactive measures to ensure smooth operations and minimize disruptions. Hence, by promptly identifying and addressing any deviations from standard or predefined operating parameters, industrial facilities may mitigate the impact of such deviations on productivity, efficiency, and overall performance.

In order to address such deviations, certain corrective actions may be implemented. Implementing the corrective actions may involve a systematic approach to diagnose and rectify the root causes of the deviations. This may encompass a range of activities, including thorough analysis, troubleshooting, maintenance, repairs, and optimization of the processes and equipment. The objective of the corrective actions may be to restore the normal function of the equipments and prevent similar issues from recurring in the future. The implementation of the corrective actions may not only resolve immediate deviations in the operating parameters of the equipments but also help improve the overall reliability and performance of the industrial facilities.

### SUMMARY OF INVENTION

This summary is provided to introduce concepts related to responding to downtime situations that ensue from deviations in operating parameters of assets of an industrial facility by identifying and taking corrective actions to manage such deviations in the operating parameters of the assets. This summary is not intended to identify essential features of the claimed subject matter nor is it intended for use in determining or limiting the scope of the claimed subject matter.

In an aspect of the present subject matter, a method for correcting a deviation in operation of an equipment in the industrial facility is disclosed. The deviation in the operation of the equipment may be owing to a deviation in operating parameters of the equipment. In an example, the method comprises monitoring the operating parameters of the equipment during the operation of the equipment. The equipment is configured to operate within a range of values predefined for each of the operating parameters of the equipment. The method further includes identifying an operating parameter of the equipment that deviates from the corresponding predefined range of values. In case the operating parameter of the equipment is identified to deviate from the corresponding predefined range of values, a dataset is queried for identifying past instances of deviation in the operating parameter. In an example, the past instances of deviation are within a specified range of deviation to the identified deviation in the operating parameter of the equipment. The dataset comprises data corresponding to a plurality of past instances of deviation in operating parameters of plurality of equipments and one or more corrective actions taken in respect of each past instance of the deviation. Thereafter, a corrective action is selected from amongst the corrective actions in the dataset. The corrective action is implemented to correct the deviation in the operating parameter associated with the equipment.

In another aspect of the present subject matter, a system to identify a corrective action to be implemented for controlling deviations in operating parameters of an equipment installed in an industrial facility is disclosed. The system includes a processor that is configured to identify an operating parameter of an equipment whose real-time value deviates from a predefined range of values of the operating parameter during the operation of the equipment. On detecting a deviating operating parameter, the processor determines attributes of the identified equipment and queries a dataset using the attributes of the identified equipment. The dataset comprises data corresponding to past instances of deviation in operating parameters of a plurality of equipments having attributes similar to the identified equipment. The dataset also comprises one or more corrective actions taken in respect of each past instance of the deviation. The processor identifies a past instance of deviation in the operating parameter and a corrective action taken in the past in respect of the identified past instance of deviation. The processor provides data required for the implementation of the corrective action to an operator so as to enable the controller to control the deviation in the operating parameter of the identified equipment.

In yet another aspect of the present subject matter, a non-transitory computer-readable medium comprising computer-readable instructions executable by a processing resource of a computing device for correcting a deviation in an industrial process is disclosed. The instructions, when executed by the processing resource, cause the processing resource to identify a real-time deviation in a key performance indicator (KPI) of an industrial process with respect to a predefined value corresponding to the KPI. A dataset, that comprises data corresponding to a plurality of past instances of deviation in the KPI of the industrial process and one or more corrective actions taken in respect of each of the past instances of deviation, is queried in the event that the KPI is found to be deviating. From the dataset, past instances of deviation in the KPI are identified and a corresponding corrective action from amongst the one or more corrective actions is selected. Data required to implement the selected corrective action is provided to an operator to enable the operator to address the deviation in the KPI of the industrial process from the corresponding predefined value of the KPI.

### BRIEF DESCRIPTION OF FIGURES

Systems and/or methods, in accordance with examples of the present subject matter, are now described and with reference to the accompanying figures, in which:

FIG. 1 illustrates a network environment for implementing example techniques to control operations in an industrial facility, in accordance with an example implementation of the present subject matter;

FIG. 2 illustrates a control system to control operations in an industrial facility, in accordance with an example implementation of the present subject matter;

FIG. 3 illustrates the control system to control the operations in the industrial facility, in accordance with another example implementation of the present subject matter;

FIG. 4 illustrates a graphical representation of stages of deviation in values of operating parameters of equipments in an industrial process, according to an example of the present subject matter;

FIG. 5 illustrates a method for controlling operations in an industrial facility, according to another example implementation of the present subject matter;

FIG. 6 illustrates a method for identifying deviation in operating parameters of equipments installed in an industrial facility, according to another example implementation of the present subject matter;

FIG. 7 illustrates a method for assigning a suitability score to one or more corrective actions taken in respect of past instances of deviation in the operating parameters of the equipments, according to another example implementation of the present subject matter; and

FIG. 8 illustrates a computing environment for controlling operations in an industrial facility, according to an example implementation of the present subject matter.

### DETAILED DESCRIPTION

Industrial facilities generally rely on a wide range of industrial assets to achieve their productivity and financial objectives. These assets include various components, such as industrial machines and equipment for carrying out industrial processes. Additionally, they include industrial controllers and associated I/O devices that regulate the operation of the equipments, peripheral systems or devices that participate in equipments' control or quality verification processes (e.g., quality check systems, industrial safety systems, motor drives, etc.), and other similar assets. Typically, these assets are configured to operate in accordance with standard operating procedures that are tailored to meet the specific requirements of the facility's processes. Adhering to these standard operating parameters ensures the safe and optimal performance of the assets within the facility.

In an industrial facility, it is possible for the performance of one or more assets to decline over time, causing the performance of the assets to deviate from the standard operating parameters defined for the optimal operation of the assets. Deviations may also occur for various other reasons, such as malfunctions, or deterioration in the raw material fed to the assets. This deviation may negatively impact the overall performance of the facility. For instance, in an LNG facility with a parallel compressor train, various factors may contribute to the train's operation deviating from its defined standard operating parameters. These factors may include changes in feedstock properties, fouling and corrosion, mechanical wear and tear, environmental conditions, and control system issues, among others. Such deviations from the standard operating parameters may result in a reduction in a KPI of the operation of the parallel compressor train, such as quality, efficiency, and/or reliability of the parallel compressor train. Therefore, to ensure optimal performance and efficiency of any industrial facility, the performance of assets installed in the facility may be monitored to detect any deviations from the predefined standard operating parameters. Promptly identifying and addressing these deviations in the assets' operating parameters allows the assets to return to their normal state of operation, aligning with the standard operating parameters and thereby aiding in maintaining the facility's KPIs or optimal performance and efficiency.

Addressing and identifying the deviations in the industrial processes or operating parameters of the assets may often require operator intervention or action. Typically, operators rely on a limited set of operational data related to the specific asset experiencing the deviation. Often, this limited data offers only partial information about the deviation in the asset's operating parameters. It may fail to provide the operator with insights regarding previous instances of deviation, the conditions during normal operations, or if the instant deviation has resulted due to past actions.

Existing techniques to resolve the deviations also lack the ability to determine if the deviation has occurred for the first time or if there were previous occurrences. They do not take into account information about past instances of the same or similar deviations, the actions taken to mitigate them, or the outcomes achieved. Due to a lack of techniques to access information pertaining to past instances of deviations in the industrial process and/or assets, the operators may be unaware of past deviations of similar nature and may overlook considerations relating to asset-process relationships that may have been previously utilized or known.

The present subject matter provides approaches for equipping the operators with insights based on historical events of deviation in the operation of the facility's assets/equipments. These approaches leverage the assets' history of deviations to guide the operators to refer to the most appropriate response when addressing deviations in the operating parameters of the assets and processes.

Example implementations of the present subject matter provide for identification of a corrective action, to address a deviation in an operating parameter of an equipment of an industrial facility, to be made based on one or more similar corrective actions taken in the past, for example, in respect of same or similar equipments involved in same or similar industrial processes as implemented in the industrial facility.

In an example, the method comprises detecting a deviation in an operating parameter of an equipment that may occur during operation of the equipment and identifying the corrective action to address the deviation. In an example, for identifying the corrective action, a dataset is queried for identifying past instances of deviation in the operating parameter of the equipment that is within a specified range of deviation to the deviation in the operating parameter associated with the equipment. The dataset may comprise data corresponding to past instances of deviation in operating parameters of the plurality of equipments and corrective actions taken in respect of the past instances of deviation. A corrective action is selected from one or more corrective actions taken in the past in respect of the deviation in the operating parameter associated with the equipment.

In an example, the selection of the corrective action may be based on a suitability score assigned to the respective corrective actions taken in respect of the past instances of deviation in the operating parameter of the equipment. The selected corrective action may have a highest suitability score in one example.

The corrective action may be implemented to correct the deviation in the operating parameter associated with the equipment. By querying the dataset, the past instances where similar deviations in the operating parameters of the equipment have been observed may be identified, thereby allowing drawing from the previous corrective actions that were effective in controlling similar deviations. The dataset thus serves as a resource to enable the selection of an appropriate corrective action for a present deviation. Thus, by leveraging corrective action taken in the past that may have been effective to remedy the deviation, the present subject matter aims to effectively control and rectify the current deviation in the operating parameter of the equipment.

Accordingly, the present subject matter enables the operators to identify states and histories of the assets, providing the operators with relevant insights and information to address ongoing deviations in the operating parameters of the assets. Therefore, when addressing deviations in the assets' operating parameters during day-to-day facility operations, the present subject matter assists operators in adopting a holistic approach to comprehend the causes and issues of the deviation, while considering the relationship between the asset and associated process that may not have been previously utilized or known. This facilitates the identification and contextualization of the current deviation by drawing comparisons to similar past deviations, and helps the operators with relevant insights and information to resolve the deviation. As a result, the present subject matter enables operators to enhance their analysis of deviation issues in operation of the assets of the facility and respond effectively to disturbances, ultimately improving situational awareness.

The present subject matter is further described with reference to the accompanying figures. Wherever possible, the same reference numerals are used in the figures and the following description to refer to the same or similar parts. It should be noted that the description and figures merely illustrate the principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

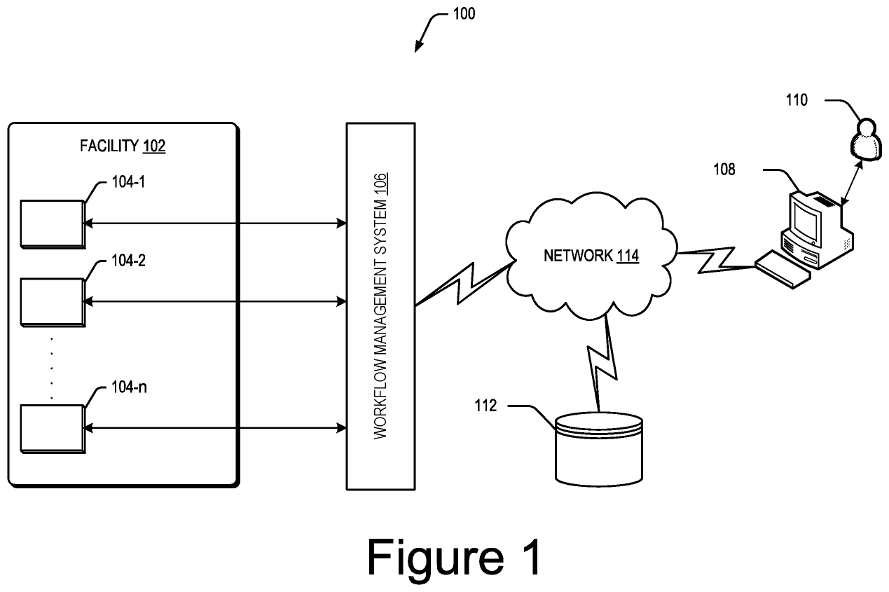

FIG. 1 illustrates a network environment 100 for implementing examples techniques to control operations in an industrial facility 102 in accordance with an example implementation of the present subject matter.

Industrial processes are carried out in the industrial facility 102 (hereinafter facility), such as oil refineries, chemical plants, paper mills, etc., wherein a plurality of equipments 104-1, 104-2 . . . , 104-n, installed in the facility 102 operate in conjunction with each other to accomplish a predefined task. For example, in the case of an HVAC system, equipments such as chillers, boilers, heat exchangers, and pumps operate in conjunction with each other to air condition a premises. The industrial process may involve chemical, electrical, or mechanical procedures for a predefined purpose, for instance, to manufacture an item or provide air conditioning or generate fire alerts.

A workflow management system (WMS hereinafter) 106 may be implemented to control the industrial process of the facility 102. The WMS 106 controls the equipments 104-1, 104-2 . . . , 104-n, such that the industrial process is performed in accordance with a standard operating procedure (SOP) to accomplish the predefined task. The WMS 106 may be any computing device, such as a server, a desktop computer, or a laptop. The WMS 106 may comprise one or more processors for executing instructions to control and monitor operating parameters of the equipments 104-1, 104-2 . . . , 104-n.

In an example, the operating parameters of an equipment may be understood as attributes of the equipment that may be controlled or measured. Examples of the operating parameters may include operational state, such as an ‘off’ or ‘on’ state of an equipment as well as variable parameters, such as temperature and pressure associated with various components of the equipment, that may be sensed, for example, by a corresponding sensor. Referring to the above example of the HVAC system implemented to air condition a premise, the equipments, i.e., the chillers, boiler, heat exchangers, and pumps operate may be operated in accordance with the predefined range of values of the operating parameters of the HVAC system, which considers various factors, such as the temperature to be maintained in the premises, ambient temperature, humidity, etc.

In an example, the WMS 106 may operate independently or be integrated into a distributed control system (DCS) (not shown in the figures). The WMS 106 may be used to specify various constraints for the DCS which may in turn monitor or control the operating parameters of the equipments 104-1, 104-2 . . . , 104-n.

To control the equipments 104-1, 104-2 . . . , 104-n, the WMS 106 may define a range of values for operating parameters of the equipments 104-1, 104-2 . . . , 104-n. In an example, the WMS 106 may be used to define the range of values for the various operating parameters in accordance with an SOP corresponding to the industrial process that the equipments 104-1, 104-2 . . . , 104-n are operable to carry out in the facility 102. For optimal operation of the industrial processes, the equipments 104-1, 104-2 . . . , 104-n are made to operate in a manner that their operating parameters remain within the predefined range of values.

As will be understood, the optimal operation of an industrial process may be defined with respect to one or more measurable objectives or KPIs that may be predefined. To achieve the one or more predefined KPIs, the industrial process may be executed in different modes. For example, a sustainability mode of the industrial process may be configured to achieve a KPI, such as a substantially small quantity of carbon emissions. Similarly, a performance mode of the industrial processes may be configured to achieve another KPI, such as a high output of the industrial process. The performance mode may achieve a higher output as opposed to the sustainability mode at the expense of carbon emissions that may be higher than in the sustainability mode. Similarly, a hybrid mode where the output of the industrial process may be lower than that in the performance mode but higher than the sustainability mode, and at the same time the carbon emission although higher than the sustainability mode is lower than the performance mode, is also possible.

Accordingly, a KPI of an industrial process may be defined as a measurable objective of the industrial process. For each of the different sets of KPIs defined for an industrial process, a corresponding mode of the industrial process may be defined. To achieve the predefined KPI corresponding to a mode of an industrial process, the equipments involved in carrying out the industrial process may have to be operated in accordance with constraints associated with the predefined KPI. For instance, in the sustainability mode, an equipment, such as a motor may not be operated above a certain level of torque if it results in a value of carbon emissions being greater than what is prescribed for the predefined KPI. The operating parameters of the equipments involved in the industrial process are thus set in accordance with the predefined KPI, and a predefined range of values may be defined for each of the operating parameters of the equipments to meet the KPI(s).

In operation, an equipment from the one or more of equipments 104-1, 104-2, . . . , 104-n installed in the facility 102, may experience a deviation in one or more of its operating parameters with respect to the corresponding range of values that is predefined, for example, to achieve one or more KPIs. In an example, the deviation may be defined as a measure of how different a current value of the operating parameters is from the range of the predefined values.

As mentioned before, the conventional method of correcting the parameters' deviation may require the involvement of an operator 110 who may typically spend a significant amount of time to diagnose the issue associated with the parameters' deviation as techniques to leverage the corrective actions taken in previous instances of similar deviations in the equipment may not be available.

To this end, the present subject matter makes available to the operator 110, information related to corrective actions taken during past occurrences of operating parameters' deviations in the equipment and underlying causes. This information may serve as a resource for the operators 110, and aid in the analysis of the issue underlying a current deviation in the equipment's operations. By leveraging this information, the operators 110 may effectively respond to the current deviations in the operating parameters of the equipments 104-1, 104-2, . . . , 104-n.

To make such information available to the operator 110, data corresponding to the corrective actions taken by various operators in response to past instances of deviation in the operating parameters of the equipments 104-1, 104-2, . . . , 104-n may be recorded, for example, by a control system 108. In another example, such data may be provided to the control system 108. In yet another example, such data may be identified and recorded by the control system 108, for example, based on detecting a deviation in any of the operating parameters of the equipments 104-1, 104-2, . . . , 104-n. In yet another example, such data may be provided manually, by the operators 110 or any other user, to the control system 108.

In an example embodiment, the data recorded in the control system 108 in respect of past instances of deviations comprises data pertaining to deviation in operating parameters of equipments 104-1, 104-2, . . . , 104-n or other equipments that are similar to the equipments 104-1, 104-2, . . . , 104-n. These equipments may be installed in the facility 102 or in a facility other than the facility 102. The recorded data may comprise the corresponding corrective actions taken by the operators for one or more of the instances of deviation.

The control system 108 may, in one example, communicate with the WMS 106 to receive the data corresponding to the corrective actions taken by the operators, in cases where such data is recorded at the WMS 106. The data corresponding to the corrective actions that are recorded by the control system 108 may be stored in a database 112 in one example. In an implementation, the database 112 may reside in the control system 108 or in the memory of the WMS 106 or alternatively may be stored in a memory of any other device, such as an external database server. Implementations, where the data corresponding to the corrective actions are recorded and stored by the WMS 106 itself, are also possible.

In one example, the control system 108, the database 112, and/or the WMS 106 may be connected over a network 114 for the purpose of obtaining data. In an example, the network 114 may be a single network or a combination of multiple networks and may use a variety of different communication protocols. The network may be a wireless or a wired network, or a combination thereof. Examples of such individual networks include, but are not limited to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN). Depending on the technology, the network 114 includes various network entities, such as gateways, and routers, however, such details have been omitted for the sake of brevity of the present description.

In an embodiment, the control system 108 may be configured to monitor a state of operation of the the equipments 104-1, 104-2, . . . , 104-n and identify and notify the operator 110 if there is a deviation in any of the operating parameters of the equipments 104-1, 104-2, . . . , 104-n. For instance, in an event of a deviation in an operating parameter of an equipment beyond a range of values predefined for said operating parameter, the control system 108 may cause an alert to be generated to notify the operator 110 of the deviation. The alert may be provided to the operator 110, for example, via a console of a control room computer in the form of a notification or warning within a pop-up window or other message format indicating the occurrence of the deviation in the operating parameter of the equipment, in one example.

To rectify the deviation, in an embodiment, the control system 108 may suggest corrective actions to assist the operator 110, for example, to bring the operating paraments of the equipment within the predefined range of values. Such corrective actions may be based on the data corresponding to the past corrective actions that are recorded by the control system 108 over a period of time.

As explained previously, an industrial process may be executed in different modes, each configured to achieve a value of one or more KPIs. If there are any deviations from this value, an intervention in the form of a corrective action from the operator 110 may be required. A deviation in a KPI may be caused by deviations in one or more operating parameters of equipments, such as the equipments 104-1, 104-2, . . . , 104-n, used in executing the industrial process. The deviation in an operating parameter of an equipment may be identified corresponding to a range of values to the operating parameter that may be predefined to achieve the KPIs.

As explained previously, the data related to the past deviations in the operating parameters of the equipments 104-1, 104-2, . . . , 104-n, and the corresponding corrective actions taken by the operators 110 in respect of each such deviation may be recorded over a period of time.

In another example, the data related to the past deviations in the operating parameters of the equipments 104-1, 104-2, . . . , 104-n may also include a cause and effect of these deviations. In an example, the cause and effects of the deviations in the parameters may be identified manually by the operators 110 based on the analysis of data related to the deviations, and a result of the analysis may be logged against each instance of the deviations. For example, in certain situations, the operating parameters of the equipments 104-1, 104-2, . . . , 104-n may be affected by a change in working conditions of the equipments 104-1, 104-2, . . . , 104-n necessitated by a change in feed type or feed rate change while carrying out the industrial processes in the facility 102. Thus, the data related to the past deviations in the operating parameters of the equipments 104-1, 104-2, . . . , 104-n may include information indicating whether the deviation was caused by a change in the working conditions of the of the equipments 104-1, 104-2, . . . , 104-n and a corresponding corrective action taken to address the deviation considering the change in the working conditions.

In yet another example, the deviations in the operating parameters of the equipments 104-1, 104-2, . . . , 104-n may occur if a measurement instrument that is used to measure the values of the operating parameters of the equipments 104-1, 104-2, . . . , 104-n has undergone any recalibration. Specifically, if the measurement instrument has been changed or not calibrated correctly to measure the accurate values of the operating parameters for the equipments 104-1, 104-2, . . . , 104-n, it may provide incorrect readings, or readings that are inconsistent with the readings prior to the recalibration, during the operation of the equipments 104-1, 104-2, . . . , 104-n. Hence, in the present example, the data related to the past deviations in the operating parameters of the equipments 104-1, 104-2, . . . , 104-n may also include the information regarding causes of the deviation in the operating parameters of the equipments 104-1, 104-2, . . . , 104-n, which, in one example, may be the change in the measurement instrument.

Similarly, in another example, the data related to the past deviations in the operating parameters of the equipments 104-1, 104-2, . . . , 104-n may include information indicating deviations in the operating parameters of the equipments 104-1, 104-2, . . . , 104-n caused due to changes in routes of any of the equipments 104-1, 104-2, . . . , 104-n. For instance, if there is a change in the route of pump A towards pump B, the change may affect the operating parameters of the pump A. Information about such changes in the routes of the equipments 104-1, 104-2, . . . , 104-n may aid the operator 110 to select appropriate corrective actions against the deviations in the values of the operating parameters of the equipments 104-1, 104-2, . . . , 104-n during an ongoing industrial operation.

In yet another example, the data related to the deviations in the operating parameters of the equipments 104-1, 104-2, . . . , 104-n may include information about indirect factors that may affect the operating parameters of the equipments 104-1, 104-2, . . . , 104-n. These indirect factors may often not be adequately monitored, however, may contribute to such deviations. Such factors may include, for example, changes in the facility 102 utilities like steam pressure, temperature, nitrogen quality, and water temperature.

Additionally, the data related to the past deviations in the operating parameters of the equipments 104-1, 104-2, . . . , 104-n may incorporate information about other external factors. These external factors may consist of operational changes in any of the equipments 104-1, 104-2, 104-n caused by external disturbances or upstream or downstream assets of the facility 102. The information about external factors may also include details about ambient temperature and weather conditions, such as rainy, summer, or winter. Furthermore, the data related to the past deviations in the operating parameters of the equipments 104-1, 104-2, . . . , 104-n may include information regarding deviations caused due to actions performed by an operator on any of the equipments 104-1, 104-2, . . . , 104-n. It may also provide insights into whether the deviation in the operating parameters was localized, affecting only a particular equipment, or if it impacted other assets within the facility 102 as well.

The present subject matter thus provides the operator 110 access to a comprehensive dataset that captures the various causes that may have led to the deviations in the operating parameters of the equipments 104-1, 104-2, . . . , 104-n in the past to aid the operator 110 in identifying the cause of a current deviation.

This dataset may enable the operator 110 to identify relevant historical equipments' states and an appropriate corrective action that may have been previously taken to resolve deviations in the operating parameters of the equipment. Based on an identification of a relevant cause of the deviation from the dataset the corrective action may be implemented to correct a current deviation in the operating parameters of an equipment. Here, the equipment' state refers to past instances of deviations in the operating parameters of a specific equipment that fall within a specified range of deviation compared to the current deviation in the operating parameter of that equipment.

The data relating to the deviations in the operating parameters of the equipments 104-1, 104-2, . . . , 104-n, causes and effects of such deviations, and the corresponding corrective actions taken by the operators 110 in respect of each such deviation may be recorded by the control system 108 or obtained from an entity that records such data. The control system 108, using this data, may construct a dataset. The dataset so created may be stored in a memory of the control system 106. In some embodiments, the dataset may be external to the control system 108, and the control system 108 may communicate with the dataset to access the dataset. This dataset may be used to make recommendations to assist the operator 110 in maintaining the operating parameters of the equipments 104-1, 104-2, . . . , 104-n within the predefined range of values.

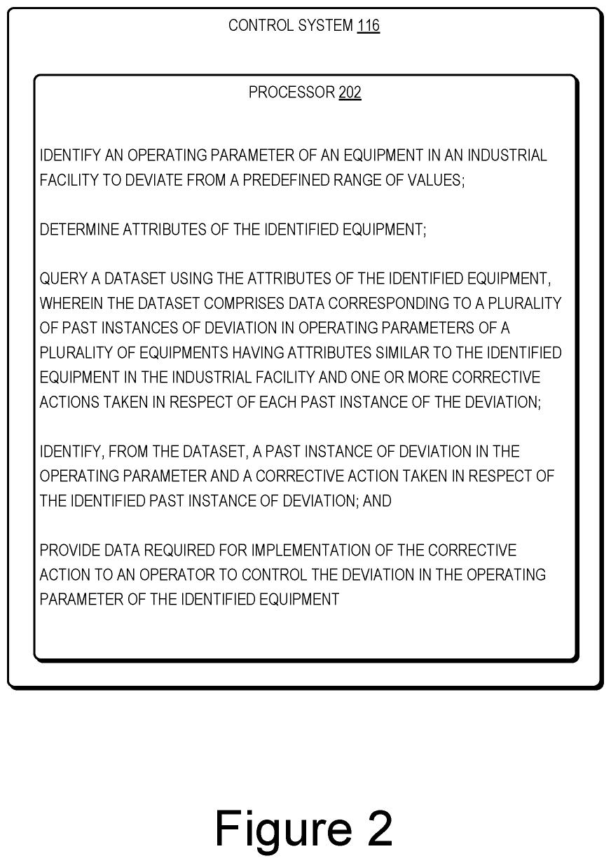

FIG. 2 shows the control system 108, according to an example implementation of the present subject matter.

As explained previously, in a given mode of an industrial process, the equipments, for example, the equipments 104-1, 104-2, . . . , 104-n, involved in carrying out the industrial process are operated to achieve the predefined KPI in accordance with constraints, such as safety and capacity constraints associated with the equipments 104-1, 104-2, . . . , 104-n. To achieve the predefined value of the KPI, the operating parameters of the equipments 104-1, 104-2, . . . , 104-n may have to be monitored and controlled during the execution of the industrial process to ensure that a range of values predefined for each of the operating parameters of the equipments is maintained during the executing of the industrial process so as to achieve the predefined KPI.

In doing so, in an example embodiment of the present subject matter, the control system 108 identifies an operating parameter of an equipment from amongst the plurality of equipments 104-1, 104-2, . . . , 104-n installed in the industrial facility 102 to deviate from its corresponding predefined range of values. Upon identifying the operating parameter of the equipment that deviates from the predefined range of values, the control system 108 further determines attributes of said equipment. The attributes of the equipment are properties of the equipment. Examples of the attributes include, but are not limited to type of the equipment, geolocation of the equipment, and identification of the equipment.

Upon identifying the attributes of the equipment, the control system 108 queries the dataset using the identified attributes of the equipment. The dataset comprises data corresponding to a plurality of past instances of deviation in operating parameters of the plurality of equipments 104-1, 104-2, . . . , 104-n having attributes similar to the equipment. The dataset also comprises information on the causes and effects of the deviation and one or more corrective actions taken in respect of each past instance of the deviation. The control system 108 queries the dataset to identify a past instance of deviation in the equipment's operating parameter within a specified range of the deviation in the operating parameter of said equipment and a corrective action taken in respect of the identified past instance of the deviation. For instance, if a compressor of a particular type is malfunctioning in the facility 102, information about a cause of the malfunctioning in the same compressor from another facility, similar to the facility 102, and corrective action taken to correct the malfunctioning may aid the operator 110 to rectify the malfunction in the compressor of the facility 102.

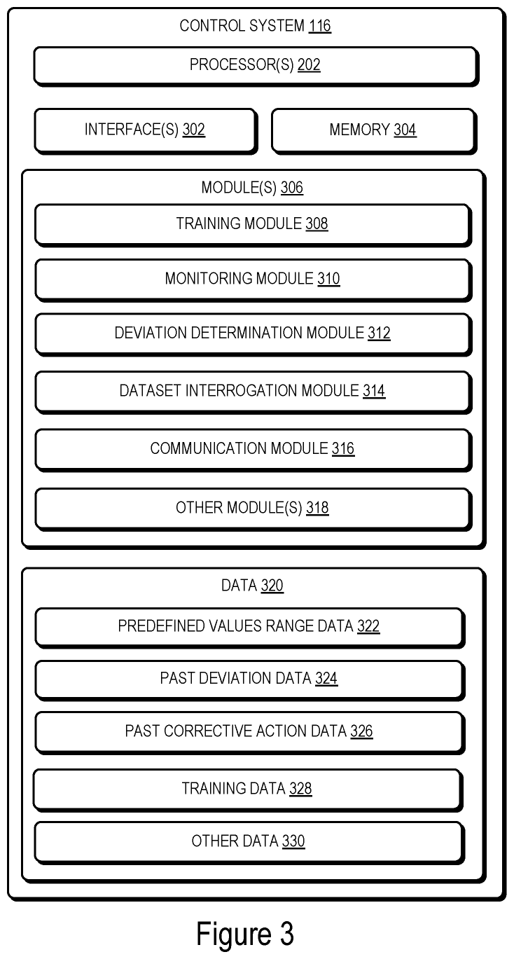

As will be explained in detail in respect of FIG. 3, a machine learning (ML) model may be installed on the control system 108 or the WMS 106. The ML model may be trained using the data stored in the dataset to identify the past instances of deviation in the operating parameter of the equipment that is within a specified range of the deviation in the operating parameter of said equipment and the corresponding corrective action taken in respect of such deviations.

In operation, the control system 108 may provide data required for the implementation of the corrective action to an operator, such as the operator 110, to control the deviation in the operating parameter of said equipment.

FIG. 3 illustrates the control system 108 according to another example implementation of the present subject matter. In an example, the control system 108 depicted in FIG. 3 may include any computing device, such as servers, desktop computers, laptops, smartphones, personal digital assistants (PDAs), and tablets.

As explained previously, an industrial process may be executed in different modes, for example, the performance mode, the sustainability mode, and the hybrid mode. Each mode may have different sets of KPIs. A weightage may be assigned to each of the KPIs. Weights to the KPIs may be given based on an output to be achieved from the industrial process. For example, from the profitability point of view, the KPIs of the performance mode may be given more weightage than the KPIs of the sustainability mode which considers environmental impact of the industrial process. As long as the industrial process executes within the predefined KPIs of the sustainability mode, and the performance mode, respectively, the industrial process may be considered to be exhibiting a normal operational behaviour. As evident, the normal operational behaviour of the industrial process may be understood as a mode of operation of the industrial process in which the industrial process performs the intended function or delivers the expected result.

In an example, the KPIs of the performance mode may include capacity, availability, and efficiency. The capacity may be indicative of numerical information or performance of an equipment, for example, a flow capacity of a pump, a system specification, a network communication speed, and the like. For example, in an industrial process, an equipment may be considered to be exhibiting the normal operating behaviour if a capacity factor of the equipment lies in a range of predefined values set for that particular industrial process.

Further, the availability may comprise an indication of whether the equipment that is required to execute the industrial process is accessible or not. For example, the availability of the equipment may be measured in terms of availability factor, and if a current value of an availability factor is determined to be on a higher side of predefined range of values of the availability factor, the same may indicate that the equipment may not fail or be unavailable for any significant period of time.

In an example, the KPI ‘availability’ may be further categorized into reliability, maintainability, and supportability. The reliability may be understood as the equipment's ability to perform its intended function with minimum instances of downtime. For instance, referring to an example of a wind farm, the wind farm may be considered to be exhibiting high reliability if an average number of failures per wind turbine per year is less than a predefined limit. The maintainability of the industrial process may be defined by the effort, for example, in terms of man-hours, required to locate and resolve operational issues in executing the industrial process. For instance, the maintainability of the wind farm may be rated higher if time to repair a failure in a wind turbine is less than 8 hours. Similarly, the supportability of the industrial process may be defined in terms of mean downtime of the equipments used to execute the industrial process. For instance, the supportability of the wind farm may be rated higher if the mean downtime of the wind turbine is less than 25 hours per failure.

Further, as explained previously, the sustainability mode provides for the execution of the industrial process through techniques that minimize negative environmental impacts, for example, techniques that allow reduction of the carbon emissions, conservation of energy, and usage of renewable resources. In an example, a KPI of the sustainability mode may be the carbon emission. The carbon emission may be the total amount of carbon and greenhouse gases discharged by the process. In an example embodiment, the sustainability mode may also include ‘economic impact’ and ‘social impact’ as predefined KPIs. For example, the KPI, ‘economic impact’ may have a high value if price of electricity generated by the wind farm is cheaper than what households in an area usually pay to purchase the electricity from other sources. Similarly, for instance, the KPI, ‘social impact’ may be given a value depending on whether or not the wind farm stops or limits local communities' ability to utilize the lands surrounding the wind farm.

The weightage given to the different KPIs may be predefined based on an analysis of operation and maintenance data of said industrial process for a specified period of time. The predefined weightage of the KPIs may be set in such a manner that the highest feasible efficiency of the industrial process may be achieved. For instance, referring to the example of the wind farm, for achieving the highest feasible efficiency of the wind farm, when generating 100 MW electricity, based on the analysis of the historical operation and maintenance data of the wind farm, the operator may assign 54% weight to the performance KPIs and 46% weight to the sustainability KPIs. If the wind farm operates within said weightage range of the performance KPIs and the sustainability KPIs, the wind farm may be considered to exhibit higher efficiency or normal operational behaviour.

In some situations, the efficiency of the industrial process may deteriorate, for example, due to certain operator actions or external disturbances, that may lead the industrial process to undergo a transition from a normal operating behaviour to a deviation behaviour. The deviation behaviour may be understood as a situation wherein the respective weightage of the performance KPIs or the sustainability KPIs changes as a result of the operator actions or external disturbances. For example, when the industrial process of generating the electricity undergoes a transition from the normal operating behaviour to the deviation behaviour, a change in current values of operating parameters of an equipment responsible for executing the industrial process may be experienced. This change in the values of the operating parameters may go beyond a range of values predefined for achieving the objective. Referring to the example of the wind farm, if there is a sudden increase in wind speed beyond an expected range, the wind turbine's rotational speed may exceed a predetermined upper limit. This deviation may lead to risks, such as increased stress on the turbine components or potential damage to such components. Similarly, if there is a decrease in wind speed or a mechanical issue, the rotational speed may drop below the lower limit, resulting in reduced power output and affecting electricity generation capacity of the wind farm.

Thus, to maintain the normal operating behaviour of the industrial process, the operating parameters of the equipments 104-1, 104-2, . . . , 104-n of the facility 102 may be measured, for example, using sensors coupled to the equipments 104-1, 104-2, . . . , 104-n and controlled as per the SOPs of the industrial process to meet the constraints, for example, safety limits, defined for the industrial process. Any deviation from the SOPs may lead to a failure of the industrial process or may result in an unexpected output. Thus, the operating parameters of the equipments 104-1, 104-2, . . . , 104-n are monitored and controlled, for example, based on the recommendations provided by the control system 108.

As explained previously, the control system 108 is configured to construct the dataset to provide recommendations or suggestions on how to control various industrial processes in order to optimize the performance of any industrial facility, such as the industrial facility 102.

In an example implementation, the control system 108 comprises the processor 202. In an example, the processor 202 may be implemented as microprocessors, microcomputers, microcontrollers, digital signal processors, central processing units, state machines, logic circuitries, and/or any devices that manipulate signals based on operational instructions. The control system 108 also comprises interface(s) 302 coupled to the processor 202. The interface(s) 302 may include a variety of software and hardware interfaces that allow interaction of the control system 108 with other communication and computing devices, such as network entities, web servers, and external repositories, and peripheral devices. For example, the interface(s) may couple the control system 108 with the WMS 106. The interface(s) 302 may also enable coupling of internal components, if any, of the control system 108 with each other.

Further, the control system 108 comprises a memory 304 coupled to the processor 202. The memory 304 may include any computer-readable medium known in the art including, for example, volatile memory (e.g., RAM), and/or non-volatile memory (e.g., EPROM, flash memory, etc.). The memory may also be an external memory unit, such as a flash drive, a compact disk drive, an external hard disk drive, or the like. The control system 108 may comprise module(s) 306 and data 320 coupled to the processor 202. In one example, the module(s) 306 and data 320 may reside in the memory 304.

In an example, the data 320 may comprise a predefined values range data 322, past deviation data 324, past corrective action data 326, training data 328, and other data 330. The module(s) 306 may include routines, programs, objects, components, data structures, and the like, which perform particular tasks or implement particular abstract data types. The module(s) 306 further includes modules that supplement applications on the control system 108, for example, modules of an operating system. The data 320 serves, amongst other things, as a repository for storing data that may be fetched, processed, received, or generated by one or more of the module(s) 306. The module(s) 306 may include a training module 308, a monitoring module 310, deviation determination module 312, dataset interrogation module 314, communication module 316, and other module(s) 318. The other module(s) 318 may include programs or coded instructions that supplement applications and functions, for example, programs in the operating system of the control system 108.

The control system 108 may itself record the data relating to the deviations in the operating parameters of the equipments 104-1, 104-2, . . . , 104-n and the corresponding corrective actions taken by the operators 110 in respect of each such deviation or receive the data from the WMS 106 or any other source that may have collected or stored such data, through a database connection over the network 114. The dataset constructed by the control system 108 using the data relating to the deviations in the operating parameters of the equipments 104-1, 104-2, . . . , 104-n and the corresponding corrective actions taken by the operators 110 in respect of each such deviation may be stored in the data 320 of the control system 108 as the training data 328.

In an example implementation, the training data 328 may be used by the training module 308 of the control system 108 to train the ML model of the training module 308. As explained previously, the training data 328 may include the data relating to the deviations in the operating parameters of the equipments 104-1, 104-2, . . . , 104-n and the corresponding corrective actions taken by the operators 110 in respect of each such deviation may be used by the training module 308 to train the ML model. The ML model may be trained to analyze the past instances of the operating parameter deviations in the equipments 104-1, 104-2, . . . , 104-n, examine the cause and effect of these deviations, and the corrective actions taken by the operators 110 to correct said deviations in the operating parameters. This analysis enables the ML model to identify and suggest changes to the operating parameters of the equipments 104-1, 104-2, . . . , 104-n, facilitating effective response to future deviations.

In accordance with an example of the present subject matter, the training data 328 may also include data corresponding to operation of the equipments 104-1, 104-2, . . . , 104-n, when they operate within the range of values, predefined for the operating parameters of the equipments 104-1, 104-2, . . . , 104-n. Accordingly, the ML model may be made to learn to predict the normal operation behaviour of the equipments 104-1, 104-2, . . . , 104—of the facility 102 based on the training data 328.

As explained previously, the control system 108 may be a standalone computing device in an example. Alternatively, in other implementations, the control system 16 may be integral to the WMS 106. In either case, the ML model is trained using training data 328 that captures the normal operational behaviour of the equipments 104-1, 104-2, . . . , 104-n, as well as the data relating to the corrective actions taken by the operator 110 in response to numerous recorded deviations in the equipments' 104-1, 104-2, . . . , 104-n operating parameters over a period of time. Once trained, the ML model may be able to suggest a corrective action to assist the operator 110 in bringing a current deviation in the operating parameter of any of the equipments 104-1, 104-2, . . . , 104-n back within the predefined range of values.

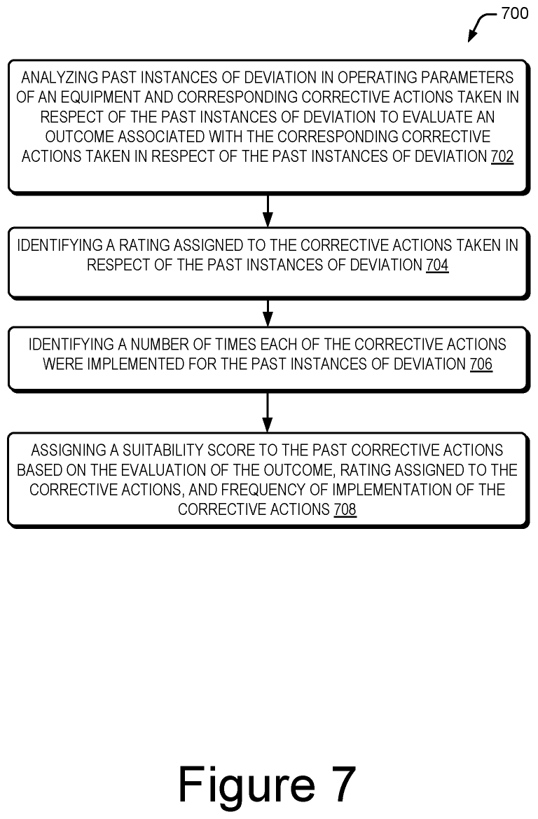

In one example, to suggest a suitable corrective action, the ML model may be trained by the training module 308 to assign a suitability score to each of the corrective actions taken in respect of each of the past instances of deviation. The training process of the ML model to assign the suitability score is explained with respect to FIG. 7.

In operation, once the trained ML model is deployed, the trained ML model may continuously or intermittently monitor the behaviour of the equipments 104-1, 104-2, . . . , 104-n during an ongoing industrial process. To monitor the behaviour of the equipments 104-1, 104-2, . . . , 104-n during the ongoing industrial process, the control system 108 may interact with the WMS 106 through the monitoring module 310 to fetch data relating to the operating parameters of the equipments 104-1, 104-2, . . . , 104-n. The monitoring module 310 monitors the operating parameters of the equipments 104-1, 104-2, . . . , 104-n. As explained previously, the operating parameters of the equipments 104-1, 104-2, . . . , 104-n are configured to operate within a range of values that is predefined for each of the operating parameters of the equipments 104-1, 104-2, . . . , 104-n. In an example embodiment, for monitoring purposes, the predefined range of values of the operating parameters of the equipments 104-1, 104-2, . . . , 104-n may be fetched from the WMS 106 by the control system 108 and stored locally as the predefined values range data 322.

Further, the deviation determination module 312 is to identify an operating parameter of an equipment from amongst the equipments 104-1, 104-2, . . . , 104-n that deviates from the predefined range of values. The deviation determination module 312 also fetches attributes of the equipment whose parameter is identified to be deviating from the predefined range of values.

Upon identifying the operating parameter of the equipment that has deviated from the predefined range of values and the attributes of said equipment, the dataset interrogation module 314 queries the training data 328 using the attributes of the identified equipment. As explained previously, the training data 328 may include the data corresponding to the plurality of past instances of deviation in the operating parameters of the plurality of equipments 104-1, 104-2, . . . , 104-n that have attributes similar to the attributes of the identified equipment. The training data 328 may also include one or more corrective actions taken in respect of each past instance of the deviation. The dataset interrogation module 314 queries the training data 328 to identify a past instance of deviation in the operating parameter of said equipment that is within a specified range of the deviation in the operating parameter of the equipment and a corrective action taken in respect of the identified past instance of deviation. In an example embodiment, the dataset interrogation module 314 selects the corrective action based on a suitability score assigned to each of the one or more corrective actions taken in respect of each of the past instances of deviation. The selected corrective action may have a highest suitability score, in an example.

In an example embodiment of the present subject matter, the communication module 316 may provide data required for implementation of the corrective action to the operator 110 to control the deviation in the operating parameter of said equipment. In an example, controlling the deviation in the operating parameter may involve modifying said operating parameter by the operator 110.

In an example implementation of the present subject matter, in an industrial facility that manufactures chemicals, there may be various equipments responsible for different stages of chemical production process. One of these equipments may be a pump, which is used for transferring liquids from one part of the facility to another. The monitoring module 310 of the control system 108 may monitor the behaviour of the pump during an ongoing industrial process using the monitoring module 310. For the purpose, the monitoring module 310 may interact with the WMS 106 to fetch data related to the operating parameters of the pump, in an example. For instance, the predefined range of values for the pump's operating parameters may include a maximum flow rate of 1000 litres per minute. However, due to a mechanical issue or other factors, the pump may start to deviate from this predefined range, and the flow rate may exceed the maximum limit, reaching 1200 litres per minute. The deviation determination module 312 detects this deviation and identifies the pump as the equipment with the operating parameter outside the predefined range. The deviation determination module 312 also fetches the attributes of the pump, such as its model, age, and maintenance history. With the attributes of the pump identified, the dataset interrogation module 314 may query the training data 328. For example, the training data 328 may be queried using various searching techniques, which may include but are not limited to keyword search, filter-based search, and so on.

The training data 328 may contain records of past instances where pumps with similar attributes have experienced deviations and one or more corrective actions that may have been taken in the past to control the deviations. The dataset interrogation module 314 searches for past instances of deviation that substantially match with current deviation. The dataset interrogation module 314 may identify a previous occurrence of deviation where the pump had a flow rate of 1120 litres per minute.

In examples, the dataset interrogation module 314 may also identify the cause of the deviation. As explained in the above-described examples, the dataset also comprises causes of deviations of the instances of deviation recorded in the past. The dataset's information about the past deviations and their respective causes provides insights regarding causes that may be investigated by operators when deviations occur, thereby facilitating effective decision-making and enabling appropriate corrective actions to be implemented in response to the deviations.

Referring again to the foregoing example of the pump for explanation, in that past instance, the dataset interrogation module 314 may identify the cause of the deviation to be a change in input feed, for example, a liquid with reduced viscosity. In that past instance, a corrective action may have been adjusting the impeller speed of the pump. Another corrective action that may be recorded may involve changing the input feed. However, the latter corrective action may have a lower suitability score compared to the former because changing the input feed may not be feasible, for example, due to procurement related constraints. Based on the suitability scores assigned to each corrective action in the past, the dataset interrogation module 314 may select the corrective action of adjusting the impeller speed from amongst the available corrective actions for similar deviations. The communication module 316 then provides the selected corrective action of adjusting the impeller speed, to an operator, such as the operator 110, responsible for the pump. The operator 110 receives this information and, based on the same, may make the required adjustments to the impeller speed to bring the flow rate of the pump back within the predefined range.

In an example, the communication module 316 also provides implementation data necessary for executing the selected corrective action, which, in one example, may include detailed steps to be performed or visual instructions guiding the operator 110 through the corrective action process.

Thus, by utilizing the dataset, the control system 108 identifies the appropriate corrective action for the specific pump deviation based on the past deviations. This proactive approach helps maintain the pump's performance and prevent potential issues that may affect the overall industrial process, ensuring efficient and reliable operation.

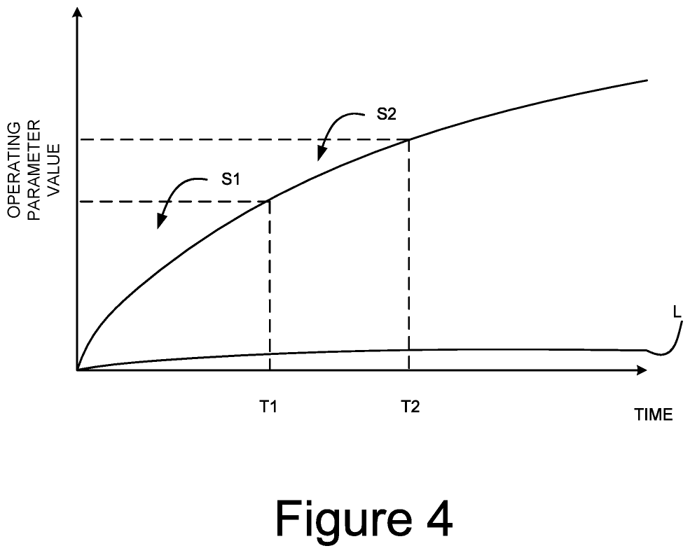

In examples, the selection of the corrective action from amongst the available corrective actions for similar deviations may be based on several factors, such as a degree of deviation in the operating parameters of the equipments 104-1, 104-2 . . . , 104, as is elaborated in reference to FIG. 4.

FIG. 4 illustrates a graphical representation of stages of deviation in values of the operating parameters of the equipments 104-1, 104-2 . . . , 104 during execution of an industrial process, according to an example of the present subject matter.

During execution of an industrial process involving the plurality of equipments 104-1, 104-2 . . . , 104, it is possible for an operating parameter of any of the equipments 104-1, 104-2 . . . , 104 to initially fluctuate within its predefined range of values. In such situations, no intervention from the operator 110 may be required. However, a deviation may be identified when a current or real-time value of the operating parameter surpasses an upper limit L of the predefined value range, as illustrated in FIG. 4.

Additionally, the deviation in the operating parameter of the equipment may not necessarily occur abruptly, but rather, it may manifest in gradual stages. To illustrate, the current deviation may move from a first stage S1 of deviation to a second stage S2 to yet another stage of deviation. The time taken for the progressive deterioration from a normal operation to the first stage S1 of deviation; from the first stage S1 of deviation to the second stage S2 and so on may be time period T1, time period T2, and so on, respectively. Same or different causes may contribute to the various stages of deviation. As a result, each stage of deviation may necessitate specific corrective actions designed to resolve the deviations effectively for the corresponding stage.

For that purpose, the control system 108 is configured to identify the first stage S1 of deviation and a second stage S2 of deviation in the operating parameter of the equipment. The first stage of deviation may be attained when the operating parameter of the equipment deviates from a mean of the corresponding predefined range of values by at least a first value and the second stage of deviation is attained when the operating parameter deviates from the mean of the corresponding predefined range of values by at least a second value. The second value is greater than the first value. Further, based on the identified stage of the deviation, a corrective action may be selected from amongst the one or more corrective actions in the dataset.

Referring once again to the example of the wind farm, during the operation of the wind turbines within the farm, one of a critical operating parameters is a blade pitch angle. Typically, the blade pitch angle fluctuates within a predefined range to optimize power generation based on wind conditions. In normal circumstances, the blade pitch angle may experience slight variations within its predefined range, which does not require any immediate intervention from the operator. However, a deviation occurs when the real-time value of the blade pitch angle exceeds the upper limit of the predefined range. For instance, if there is a sudden gust of wind, the blade pitch angle may increase beyond the predefined upper limit. The deviation in the blade pitch angle may not happen abruptly, but instead, it may manifest in stages. For example, during the time period T1, the blade pitch angle may start deviating slightly due to moderate wind conditions. This may be considered the first stage of deviation. Then, during the time period T2, strong winds may cause a more significant deviation in the blade pitch angle, representing the second stage of deviation. To address each stage of deviation effectively, different corrective actions may be required. For instance, during the first stage, the wind farm's control system may adjust the turbine's control parameters to mitigate the slight deviation. However, during the second stage, a more aggressive corrective action, such as feathering the blades or shutting down the turbine temporarily, may be necessary to ensure the safety and efficiency of the wind turbine.

In another example implementation, selecting the corrective action from amongst the one or more corrective actions may include assessing a rate of deviation based on the time taken to move from the first stage S1 of deviation to the second stage S2 of the deviation. For instance, the corrective action that is selected if the progressive deterioration from the normal operation to the first stage S1 of deviation, then to the second stage S2 and so on, occurs at a low pace may be different from the corrective action that is selected to address the deviation if the deterioration were to happen at a rapid pace. As will be understood, the latter instance of deviation may be needing more drastic corrective actions as compared to the former. The rate at which the operating parameter of the equipment changes to move away from the corresponding normal value may, thus, be a consideration in the selection of the corrective action.

Referring once again to the example of the wind farm, the wind speed may be the operating parameter being monitored for deviation. The wind farm's control system may continuously measure and analyse the wind speed to ensure optimal power generation. During the first stage S1 of the deviation, there may be a gradual increase in the wind speed beyond a predefined operating range due to changing weather conditions. The control system of the wind farm tracks the time it takes for the wind speed to exceed a predefined operating range and transition to the second stage S2 of the deviation. If the duration between the first stage S1 and the second stage S2 of the deviation is longer than a threshold, indicating a slow progression, the corrective action may involve adjusting the turbine's control parameters or optimizing the blade pitch angle to manage the increased wind speed effectively. The control system of the wind farm may gradually make these adjustments to maintain stable turbine operation and maximize power generation. However, if a rapid progression is detected, the control system may implement corrective measures, such as immediately feathering the turbine blades or initiating an emergency shutdown protocol.

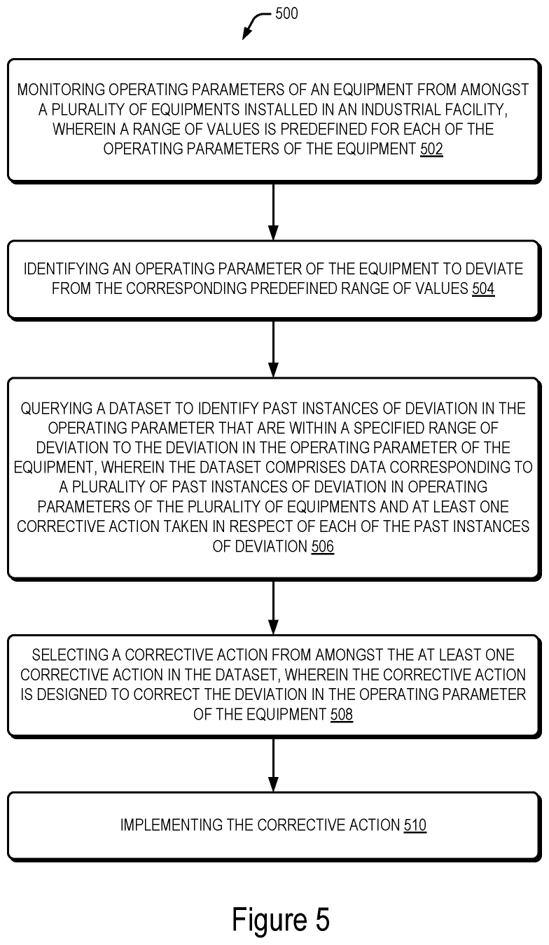

FIG. 5 illustrates a method 500 for controlling operations in an industrial facility, such as the industrial facility 102, according to an example. Although the method 500 may be implemented in a variety of computer-based systems, for ease of explanation, the present description of the example method 500 to control operations in the industrial facility 102 is provided in reference to the above-described control system 108.

The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that blocks of the method 500 may be performed by programmed computing devices. The blocks of the method 500 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 5, at block 502, operating parameters of an equipment, such as equipments 104-1, 104-2 . . . , 104-n involved in the industrial process are monitored, for example, using the monitoring module 310. As explained previously, a range of values may be predefined for each of the operating parameters of the equipment, and during the operation of the equipment, the operating parameters of the equipment are to lie within the predefined range of values for the optimal operation of the industrial processes. As discussed previously, the range of values of the operating parameters may be predefined so as to achieve an optimum output of the industrial process while simultaneously complying with various constraints.

At block 504, based on monitoring, an operating parameter of the equipment that deviates from the corresponding predefined range of values is identified by the deviation determination module 312. As explained previously, the deviation in the operating parameter of the equipment may refer to situations where the operating parameter of the equipment is not within a predefined range of values as expected, i.e., a real-time value of the one or more operating parameters of the equipment is outside the corresponding predefined range of values and may require the operator 110 intervention/action to resolve such deviation.

Based on the deviation in the operating parameters of the equipment identified at block 504, at block 506, the dataset interrogation module 314 queries a dataset, such as the training data 328, to identify past instances of deviation in the operating parameter of the equipment. As explained previously, the dataset comprises data corresponding to a plurality of past instances of deviation in operating parameters of the plurality of equipments 104-1, 104-2 . . . , 104-n and one or more corrective actions taken in respect of each of the past instances of deviation. In an example, only those past instances of deviations that have values of deviation within a specified range of deviation vis-à-vis deviation in the operating parameter of the equipment are considered.

Based on the querying of the dataset at block 506, at block 508, a corrective action is selected by the dataset interrogation module 314 from amongst the one or more corrective actions in the dataset. The corrective action may be designed to correct the deviation in the operating parameter of the equipment. As discussed previously, the corrective action may be selected based on a suitability score assigned to each of the one or more corrective actions taken in respect of each of the past instances of deviation. In operation, the corrective action that is selected by the dataset interrogation module 314 has the highest suitability score.

Once the corrective action is selected at block 508, at block 510, the selected corrective action may be implemented by the operator 110 to control the deviation in the operating parameter of the identified equipment. In an example implementation, the corrective action may be provided together with data that may contain necessary information required for the implementation of the corrective action. For example, when addressing a deviation in temperature of an industrial oven, the selected corrective action may include the associated data that provides information on a desired temperature range and necessary adjustments. An operator, such as the operator 110, may implement the corrective action by modifying the temperature control settings to bring the temperature back within the predefined range. This data may be stored in the dataset and linked to the respective corrective action. In another example, the control system 108 may fetch data from the WMS 106. In an operation, implementing the corrective action may include modifying the operating parameter that deviates from the predefined range of values.

Thus, promptly identifying and addressing the deviations in the equipments' operating parameters allows the operators 110 to take corrective actions to return the equipments to their normal state of operation, aligning with the SOPs of the facility 102 and thereby aiding in maintaining the facility's optimal performance and efficiency.

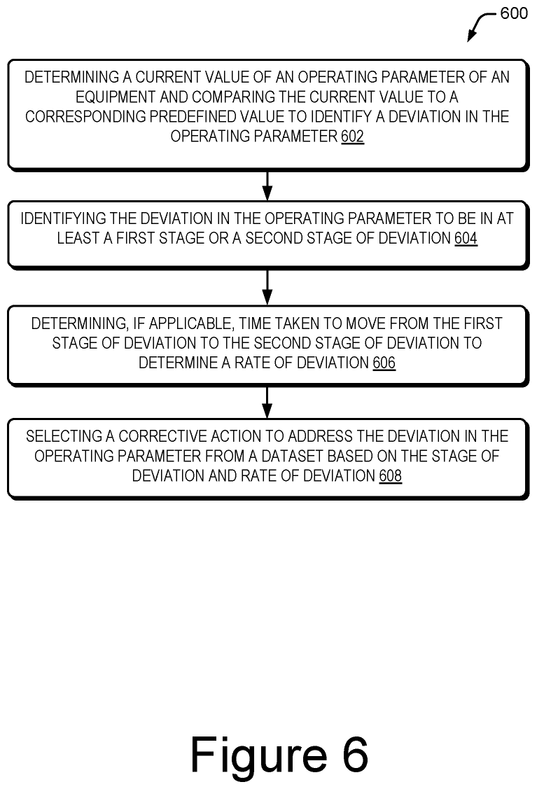

FIG. 6 illustrates a method for identifying and addressing a deviation in an operating parameter of an equipment from the plurality of equipments 104-1, 104-2 . . . , 104-n installed in the industrial facility 102, according to another example implementation of the present subject matter.

Although the method 600 may be implemented in a variety of computer-based systems, for ease of explanation, the present description of the example method 600 to identify and address the deviation in the operating parameter of the equipment is provided in reference to the above-described control system 108.

The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that blocks of the method 600 may be performed by programmed computing devices. The blocks of the method 600 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 6, at block 602, a current value of the operating parameter of the equipment is determined and compared to a corresponding predefined range of values to identify a deviation in the operating parameter. As explained previously, the range of values may be predefined for each of the operating parameters of the equipment, and during the operation of the equipment, the operating parameters of the equipment are to lie within the predefined range of values for the optimal operation of the industrial processes.

At block 604, the deviation in the operating parameter is identified to be in at least the first stage S1 or the second stage S2 of the deviation. In an example, the first stage S1 of the deviation may be understood as an initial phase of the deviation where the operating parameter of the equipment starts to show changes outside the predefined range of values, indicating a potential deviation from the normal operating behaviour. Whereas the second stage S2 of the deviation may be understood as a subsequent phase of the deviation where the operating parameter of the equipment deviates further, exceeding the predefined value range or the upper limit, requiring the corrective actions to address the deviation.

At block 606, a rate of deviation is determined by assessing the time required to transition from the first stage S1 to the second stage S2 of deviation. Referring to the example of the wind farm, in the first stage S1 of deviation, the wind speed gradually increases due to changing weather conditions. The control system of the wind farm monitors the time it takes for the wind speed to surpass a predefined threshold and enter the second stage S2 of deviation. By assessing the time taken to move from the first stage S1 to the second stage S2 of deviation, wind farm operator may evaluate the rate at which the deviation is occurring. This information may allow the operator to gauge the severity and urgency of the situation, enabling appropriate corrective actions to be taken in response to the deviation.

At block 608, a corrective action may be selected to address the deviation in the operating parameter of the equipment from the dataset based on the stage of deviation and rate of deviation, as explained previously.

FIG. 7 illustrates a method for assigning a suitability score to one or more corrective actions taken in respect of past instances of deviation in the operating parameters of the equipments 104-1, 104-2 . . . , 104-n, according to another example implementation of the present subject matter.

Although the method 700 may be implemented in a variety of computer-based systems, for ease of explanation, the present description of the example method 700 to assign the suitability to score to the one or more corrective actions taken in respect of past instances of deviation is provided in reference to the above-described control system 108.

The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or combination thereof.

It may be understood that blocks of the method 700 may be performed by programmed computing devices. The blocks of the method 700 may be executed based on instructions stored in a non-transitory computer-readable medium, as will be readily understood. The non-transitory computer-readable medium may include, for example, digital memories, magnetic storage media, such as magnetic disks and magnetic tapes, hard drives, or optically readable digital data storage media.

Referring to FIG. 7, at block 702, a plurality of past instances of deviation in the operating parameters of the plurality of equipments 104-1, and the corresponding corrective action taken in respect of each of the past instances of deviation is analyzed and an outcome associated with the corresponding corrective action taken in respect of each of the past instances of deviation is evaluated. In one example, the evaluation of the outcome may be based on a user input, such as the operator 110. For instance, the operator 110 may evaluate the outcome and give inputs to assign a score to the corrective action taken to control and reverse the deviation.

At block 704, a rating is assigned to each of the corrective actions taken in respect of each of the past instances of deviation identified. In an example, the rating may be assigned by the operator 110 indicating the perceived effectiveness or success of the corrective action.

At block 706, a number of times each of the corrective actions were implemented for the past instances of deviation is identified.

At block 708, a suitability score is assigned to each of the corrective actions. This score takes into account the evaluation of the outcomes resulting from the corrective action, the ratings assigned to the corrective actions, and frequency of implementation for each corrective action. For example, considering a manufacturing plant with various equipments, past instances of deviations in operating parameters of the equipments may have occurred, such as temperature fluctuations or pressure variations. The corresponding corrective actions taken to resolve the deviations may include adjusting control settings or performing maintenance procedures. During the analysis, the outcomes associated with each corrective action are evaluated. The operator assigns ratings based on their assessment of the corrective actions' effectiveness. The control system 108 also records the number of times each corrective action was implemented for the past instances of deviation. Based on the evaluation of outcomes, assigned ratings, and frequency of the implementation, suitability scores are assigned to each corrective action. These scores help determine the most appropriate corrective actions to be employed in response to future deviations, considering their track record and perceived effectiveness.

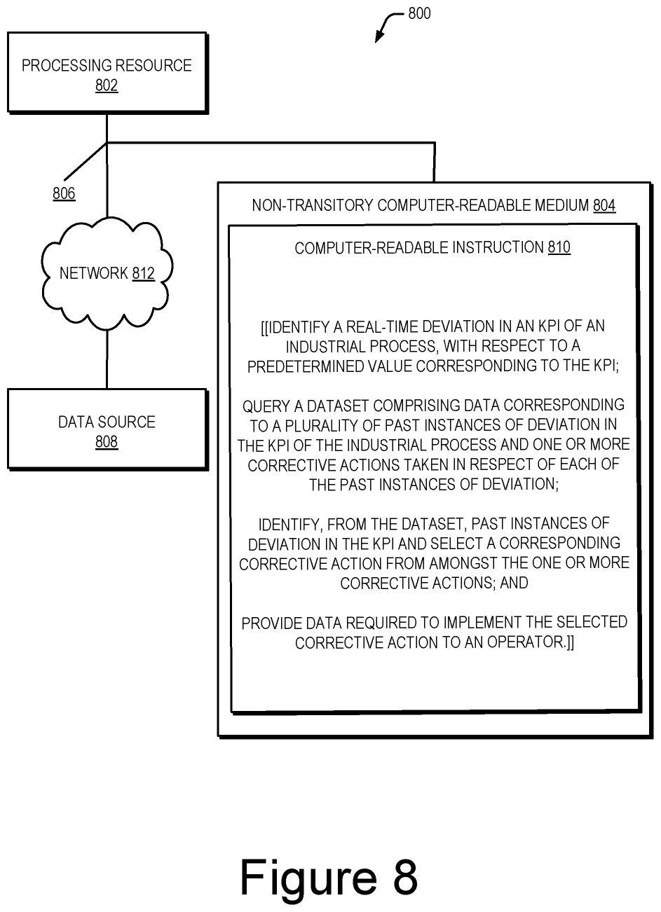

FIG. 8 illustrates a computing environment 800 for controlling operations in an industrial facility, such as the facility 102, according to an example. In an example implementation, the computing environment 800 may comprise a computing device, such as the control system 108. The computing environment 800 includes a processing resource 802 communicatively coupled to a non-transitory computer-readable medium 804 through a communication link 806. In an example, the processing resource 802 may be a processor of the computing device, such as the processor 202 of the control system 108, that fetches and executes computer-readable instructions from the non-transitory computer-readable medium 804.

The non-transitory computer-readable medium 804 may be, for example, an internal memory device or an external memory device. In an example implementation, the communication link 806 may be a direct communication link, such as any memory read/write interface. In another example implementation, the communication link 806 may be an indirect communication link, such as a network interface. In such a case, the processing resource 802 may access the non-transitory computer-readable medium 804 through a network 812. The network 812 may be a single network or a combination of multiple networks and may use a variety of different communication protocols.

The processing resource 802 and the non-transitory computer-readable medium 804 may also be communicatively coupled to data source(s) 808. The data source(s) 808 may be used to store historical data corresponding to operation of a system over a time period, in an example. The system may comprise one or more equipments involved in the industrial process that is to be monitored. The system may be a part of a facility or a plant where the industrial process is carried out, for example, in accordance with SOPs.

As explained previously, the optimal operation of an industrial process may be linked with one or more KPIs that may be predefined. The KPI of an industrial process may be defined as a measurable objective of the industrial process. A mode of operation of the industrial process may be configured, for example, the above-mentioned sustainability mode, or performance mode corresponding to a set of KPIs. The equipments, such as the equipments 104-1, 104-2 . . . , 104-n, involved in carrying out the industrial process are operated to achieve the predefined value of the KPIs, in accordance with associated constraints.

To achieve the predefined value of the KPIs for the optimal operation of the industrial process, a real-time value of the KPIs may be monitored and controlled during the execution of the industrial process.

Accordingly, in an example implementation, the non-transitory computer-readable medium 804 comprises computer-readable instructions 810 for identifying a real-time deviation in a KPI of an ongoing industrial process with respect to a predetermined value corresponding to the KPI. As will be understood from the above explanation, there may be different sets of KPIs defined for the industrial process, and for each of the different sets of KPIs defined for the industrial process, a corresponding mode of operation of the industrial process may be configured.

In an example, in an event of identifying a deviation, the instructions 810 cause the processing resource 802 to query a dataset that is similar to the dataset explained in reference to FIGS. 1 to 7. The dataset comprises data corresponding to a plurality of past instances of deviation in the KPI of the industrial process and one or more corrective actions taken in respect of each of the past instances of deviation.

In an example, the instructions 810 cause the processing resource 802 to identify, based on querying, past instances of deviation in the KPI and select a corresponding corrective action from amongst the one or more corrective actions. For example, to correct a deviation in a pump flow rate, the corrective action may involve adjusting the pump speed or inspecting and cleaning the pump components to ensure smooth flow.

Thereafter, the instructions 804 cause the processing resource 802 to provide the data required to implement the selected corrective action to an operator, such as the operator 110. For example, if the corrective action is modification of the operating parameters of the equipments 104-1, 104-2 . . . , 104-n to bring the operation of the equipments 104-1, 104-2 . . . , 104-n within the constraints associated with the KPI, then the data may comprise steps to be followed to modify the operating parameters of the equipments 104-1, 104-2 . . . , 104-n, thereby correcting the deviation in the KPI. As explained previously, the corrective action may be selected based on a suitability score assigned to the respective corrective actions taken in respect of the past instances of deviation in the KPI. In operation, the corrective action that is selected from the dataset may have a highest suitability score.

In an example embodiment, the instructions 804 cause the processing resource 802 to execute the industrial process in one or more modes, such as the performance mode and the sustainability mode, with each mode having their own predefined KPIs. A value of the KPIs may be predetermined for each mode. The instructions 804 may cause the processing resource 802 to determine a real-time mode of the industrial process to identify the deviation.

In another example embodiment, the instructions 804 cause the processing resource 802 to identify stages of deviation, such as the first stage of deviation and the second stage of deviation, as explained previously. The first stage of deviation is attained when the KPI deviates from the predefined value by a first value and the second stage of deviation is attained when the KPI deviates from the predefined value by a second value. The second value is greater than the first value. The corrective action is selected from amongst the one or more corrective actions in the dataset based on the identified at least first stage of deviation and second stage of deviation. The selection of the corrective action is dependent on a time taken to move from the first stage of deviation to the second stage of deviation.

Thus, the methods and systems of the present subject matter provide techniques for assisting operators in controlling an industrial process by adopting a holistic approach that considers a relationship between the assets and associated processes that execute the industrial process and that may not have been previously utilized or known. Although implementations of controlling the industrial process have been described in a language specific to structural features and/or methods, it is to be understood that the appended claims are not necessarily limited to the specific features or methods described. Rather, the specific features and methods are disclosed as example implementations for controlling the industrial process, for instance, based on recommendations generated from a trained machine learning model.

1. A method to control operations in an industrial facility, the method comprising:
monitoring operating parameters of an equipment from amongst a plurality of equipments installed in the industrial facility, wherein a range of values is predefined for each of the operating parameters of the equipment;
identifying an operating parameter of the equipment to deviate from the corresponding predefined range of values;
querying a dataset to identify past instances of deviation in the operating parameter that are within a specified range of deviation to the deviation in the operating parameter of the equipment, wherein the dataset comprises data corresponding to a plurality of past instances of deviation in operating parameters of the plurality of equipments and at least one corrective action taken in respect of each of the past instances of deviation;
selecting a corrective action from amongst the at least one corrective action in the dataset, wherein the corrective action is designed to correct the deviation in the operating parameter of the equipment; and
implementing the corrective action.

2. The method of claim 1, wherein identifying the operating parameter of the equipment to deviate from the corresponding predefined range of values comprises identifying at least a first stage of deviation and a second stage of deviation, the first stage of deviation being attained when the operating parameter deviates from a mean of the corresponding predefined range of values by at least a first value and the second stage of deviation being attained when the operating parameter deviates from the mean of the corresponding predefined range of values by at least a second value, the second value being greater than the first value; and wherein
selecting the corrective action from amongst the at least one corrective action in the dataset is based on the identified at least first stage of deviation and second stage of deviation.

3. The method of claim 2, wherein identifying the operating parameter of the equipment to deviate from the corresponding predefined range of values comprises assessing time taken to move from the first stage of deviation to the second stage of deviation, and wherein
selecting the corrective action from amongst the at least one corrective action from the dataset is based on the assessed time.

4. The method of claim 1, wherein implementing the corrective action comprises modifying at least one of the operating parameter of the equipment.

5. The method of claim 1, wherein the corrective action is selected based on a suitability score assigned to the at least one corrective action taken in respect of each of the past instances of deviation, wherein the selected corrective action has a highest suitability score.

6. The method of claim 5, wherein assigning the suitability score comprises employing a machine learning model to analyze the dataset for analysing the plurality of past instances of deviation in operating parameters of the plurality of equipments and the corresponding corrective action taken in respect of each of the past instances of deviation to evaluate an outcome associated with the corresponding corrective action taken in respect of each of the past instances of deviation.

7. The method of claim 5, wherein the suitability score is assigned based on a number of times the corrective action was implemented for the past instances of deviation.

8. A system to control an industrial facility comprising:
a processor to:
identify an operating parameter of an equipment in the industrial facility to deviate from a predefined range of values;
determine attributes of the equipment;
query a dataset using the attributes of the equipment, wherein the dataset comprises data corresponding to a plurality of past instances of deviation in operating parameters of a plurality of equipments having attributes similar to the equipment in the industrial facility and one or more corrective actions taken in respect of each past instance of the deviation;
identify, from the dataset, a past instance of deviation in the operating parameter and a corrective action taken in respect of the identified past instance of deviation; and
provide data required for implementation of the corrective action to an operator to control the deviation in the operating parameter of the identified equipment.

9. The system of claim 8, wherein the processor is to identify the operating parameter of the equipment to deviate from the predefined range of values by identifying at least a first stage of deviation and a second stage of deviation, the first stage of deviation being attained when the operating parameter deviates from a mean of the corresponding predefined range of values by a first value and the second stage of deviation being attained when the operating parameter deviates from the mean of the corresponding predefined range of values by a second value, the second value being greater than the first value; and
select the corrective action from amongst the one or more corrective actions in the dataset based on the identified at least first stage of deviation and second stage of deviation.

10. The system of claim 8, wherein the plurality of equipments having attributes similar to the equipment in the industrial facility are located at sites other than the industrial facility.

11. The system of claim 8, wherein the implementation of the corrective action comprises modifying the operating parameter of the equipment that is identified to be deviating from the predefined range of values.

12. The system of claim 8, wherein the dataset further comprises data corresponding to one or more causes of deviation for each of the plurality of past instances of deviation in the operating parameters of the plurality of equipments.

13. A non-transitory computer readable medium comprising computer-readable instructions that when executed cause a processing resource of a computing device to:
identify a real-time deviation in a key performance indicator (KPI) of an industrial process, with respect to a predetermined value corresponding to the KPI;
query a dataset comprising data corresponding to a plurality of past instances of deviation in the KPI of the industrial process and one or more corrective actions taken in respect of each of the plurality of past instances of deviation;
identify, from the dataset, past instances of deviation in the KPI and select a corresponding corrective action from amongst the one or more corrective actions; and
provide data required to implement the selected corrective action to an operator.

14. The non-transitory computer readable medium of claim 13, wherein the industrial process is configured to execute in at least one mode, and wherein the predetermined value of the KPI is defined for each mode, and wherein the computer-readable instructions further cause the processing resource to determine a real-time mode of the industrial process to identify the real-time deviation.

15. The non-transitory computer readable medium of claim 14, wherein the at least one mode of the industrial process comprises a sustainability mode, wherein a predetermined value of carbon emission is defined for the industrial process in the sustainability mode; and a performance mode, and wherein a predetermined value of capacity, availability, or efficiency is defined for the industrial process in the performance mode.

16. The non-transitory computer readable medium of claim 13, wherein the corrective action is selected based on a suitability score assigned to the each of the one or more corrective actions taken in respect of each of the plurality of past instances of deviation.

17. The non-transitory computer readable medium of claim 16, wherein the computer-readable instructions further cause the processing resource to evaluate an outcome associated with the each of the one or more corrective actions taken in respect of each of the past instances of deviation to assign the suitability score.

18. The non-transitory computer readable medium of claim 13, wherein the computer-readable instructions further cause the processing resource to identify at least a first stage of deviation and a second stage of deviation, the first stage of deviation being attained when the KPI deviates from the predetermined values by a first value and the second stage of deviation being attained when the KPI deviates from the predefined values by a second value, the second value being greater than the first value; and wherein
the computer-readable instructions further cause the processing resource to select the corrective action from amongst the one or more corrective actions in the dataset based on the identified at least first stage of deviation and second stage of deviation.

19. The non-transitory computer readable medium of claim 18, wherein the computer-readable instructions further cause the processing resource to assess time taken to move from the first stage of deviation to the second stage of deviation, and wherein
the computer-readable instructions further cause the processing resource to select the corrective action from amongst the one or more corrective actions from the dataset is selected based on the assessed time.

20. The non-transitory computer readable medium of claim 13, wherein implementation of the corrective action comprises modifying one or more parameters of the KPI of the industrial process to bring value of the KPI within the predetermined value.
